(19) United States
(12) Patent Application Publication
(10) Pub. No.: US 2012/0130950 A1
(43) Pub. Date: May 24, 2012

(54) DATA REPLICATION TO MULTIPLE DATA NODES

(75) Inventors: Prateek Jain, Tustin, CA (US); Don Matsubayashi, Tustin, CA (US)

(73) Assignee: CANON KABUSHIKI KAISHA, Tokyo (JP)

(21) Appl. No.: 12/952,820

(22) Filed: Nov. 23, 2010

(51) Int. Cl. G06F 17/30; G06F 7/00

(52) U.S. Cl. 707/634; 709/223; 707/E17.005

(57) ABSTRACT

In a distributed file system, replicating data to multiple data nodes including first and second data nodes includes monitoring a stream of data in a channel of communication through a tunnel between a client and the first data node. A channel of communication is established via a direct connection to the second data node. In parallel with monitoring of the stream through the tunnel, the data in the stream through the tunnel is replicated to the second data node using the channel of communication via the direct connection to the second data node.

### FIELD

The invention relates to the field of data replication, and more particularly relates to replicating data to multiple data nodes including first and second data nodes in a distributed file system (DFS).

### BACKGROUND

In a DFS, replication pipelining can be used to replicate data blocks across multiple participating nodes available in a cluster. In conventional replication pipelining schemes, data is typically replicated to all the participating nodes in the cluster sequentially, simulating the flow in a pipeline where the node that just received the data block successfully acts as the data source for the next participating data node in the pipeline.

The above replication pipelining scheme can provide for improved availability and reliability in a DFS. In addition, the scheme can be associated with ease of implementation in the case of error handling, and with simplified design for a DFS client which needs to handle communication with only one data node at a time.

### SUMMARY

One problem associated with conventional replication pipelining schemes is the increased time at which data is made available for reading for a given data block. This problem is typically exacerbated when there is a high replication factor, large data files, and/or large minimum block sizes in the DFS instance.

When using the above replication pipelining scheme, a data block is typically made available for reading only once it is successfully copied to all the participating replication nodes. This can significantly increase the time to wait before the first use of a data block in a DFS system with a high replication factor. More specifically, a data block is typically copied to one participating replication node in the cluster at a time, while the other participating nodes in the cluster may be idly sitting with available network bandwidth, hence introducing propagating sequential delay in availability of a given data block.

Furthermore, extremely large files will typically have a high number of constituent data blocks and can adversely affect the data availability time, given the overhead involved in handling the block level replication. In this regard, the usage of large minimum block sizes can mitigate the adverse effect of extremely large file sizes, by reducing the block handling overheads. However, the large block size typically requires a longer wait period at each replication node, in order to complete the data write at that node before moving on to the next node.

The present disclosure addresses the foregoing problems. Disclosed embodiments describe replicating data to multiple data nodes including first and second data nodes. In parallel with monitoring a stream of data in a channel of communication through a tunnel between a client and the first data node, the data in the stream through the tunnel is replicated to the second data node using a channel of communication via a direct connection to the second data node.

In an example embodiment described herein, data is replicated to multiple data nodes including first and second data nodes. A stream of data is monitored in a channel of communication through a tunnel between a client and the first data node. A channel of communication is established via a direct connection to the second data node. In parallel with monitoring of the stream through the tunnel, the data in the stream through the tunnel is replicated to the second data node using the channel of communication via the direct connection to the second data node.

The establishing of the channel of communication to the second data node can comprise impersonating the client relative to the second data node. The data can comprise plural data blocks, and parallel operation can comprise sending one of the data blocks to the first and second data nodes simultaneously. In addition, a channel of communication can be established via a direct connection to a third data node, and the data stream through the tunnel to the third data node can be replicated using the channel of communication via the direct connection to the third data node.

The second data node can be identified within a list of data nodes for data replication. An acknowledgment can be received from each of the first and second data nodes upon completion of data transfer. The data can be replicated on a per-block basis, wherein a data file is divided into data blocks, and the nodes participating in the replication for each data block differ from nodes participating for other data blocks.

In a further example embodiment, a distributed file system (DFS) comprises a client node having data for replication, first and second data nodes, and a switch which includes a data tunnel between the client node and the first data node. The DFS further comprises a controller which receives instructions from the client node to replicate the data to the second data node, and which controls the switch to replicate the data to the second data node. The switch is further constructed to open a data channel with the second data node, to monitor data through the tunnel to the first data node, to impersonate the client relative to the second data node, and to replicate data to the second node via the data channel in parallel with monitoring of data through the tunnel to the first data node.

The switch can further be constructed to open multiple channels to multiple data nodes, to impersonate the client relative to each of the multiple data nodes, and to replicate the data monitored through the channel to the first data node to all of the multiple data nodes. In example embodiments, the switch is a network switch with real-time flow modification capabilities. The data can be replicated on a per-block basis, wherein a data file is divided into data blocks, and the nodes participating in the replication for each data block differ from nodes participating for other data blocks.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a depiction of a network environment which provides for data replication to multiple data nodes according to an example embodiment.

FIG. 2 is a block diagram depicting the internal architecture of a client in FIG. 1 according to an example embodiment.

FIG. 3 is a block diagram depicting the internal architecture of a primary host or secondary host shown in FIG. 1 according to an example embodiment.

FIG. 4 is a block diagram depicting a system for replication pipelining to multiple nodes in sequence.

FIG. 5 is a block diagram depicting a system for replicating data to multiple nodes in parallel, according to an example embodiment.

FIGS. 6A and 6B are block diagrams depicting data replication on a per-block basis according to an example embodiment.

FIG. 7 is a block diagram depicting a system which uses a TCPMocker for replicating data to multiple nodes in parallel, according to an example embodiment.

FIG. 8 is a flow diagram illustrating data replication to multiple data nodes according to an example embodiment.

### DETAILED DESCRIPTION

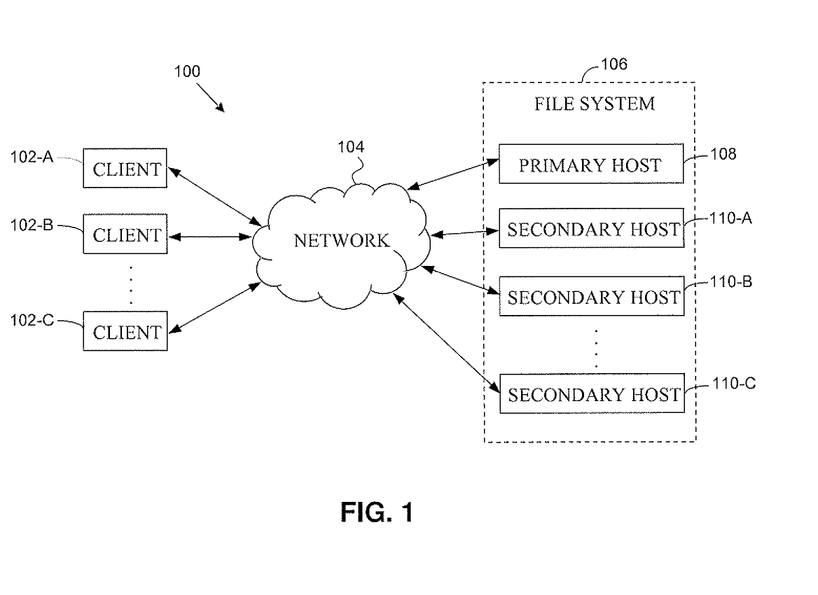

FIG. 1 is a depiction of a network environment which provides for data replication to multiple data nodes according to an example embodiment. Network environment 100 can include clients 102-A to 102-C (collectively referred to as clients 110), primary host 108, and secondary hosts 110-A to 110-C (collectively referred to as secondary hosts 110) connected via a network 104.

Network environment 100 can provide for data replication to multiple data nodes, which can correspond to primary host 108 and secondary hosts 110. More particularly, data sent to primary host 108 by clients 102 can be replicated to one or more of secondary hosts 110. In addition, primary host 108 and secondary hosts 110 can form a file system 106.

Network 104 can correspond to an internal network within a data center. For example, network 104 can be a local area network (LAN). Clients 102, primary host 108 and secondary hosts 110 can connect to network 104 via wired, wireless, optical, or other types of network connections.

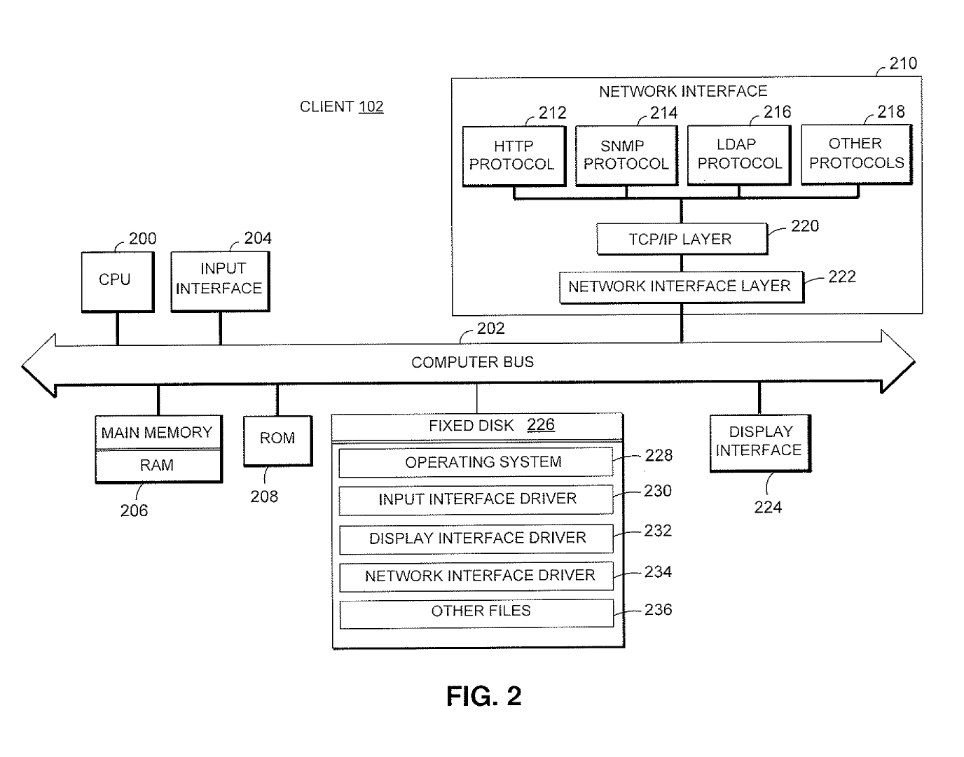

FIG. 2 is a block diagram depicting the internal architecture of a client in FIG. 1 according to an example embodiment. In the example of FIG. 2, client 102 can correspond to a personal computer. However, it should be noted that client 102 can correspond to one or more types of devices, such as a personal (or laptop) computer, a cellular phone, a personal digital assistant (PDA), or another type of communication device, a thread or process running on one of these devices, and/or objects executable by these devices. In the example of FIG. 2, the internal architectures for these other types of devices will not be described with the same amount of detail as a personal computer.

In addition, client 102 can include, or be linked to, an application on whose behalf client 102 communicates with primary host 108 or secondary hosts 110 to read or write file data. In example embodiments, client 102 can perform some or all of the functions of primary host 108 or secondary hosts 110, and primary host 108 or secondary hosts 110 may perform some or all of the functions of client 102.

As can be seen in FIG. 2, client 102 can include a central processing unit (CPU) 200 such as a programmable microprocessor which can be interfaced to computer bus 202. Also coupled to computer bus 202 can be a input interface 204 for interfacing to an input device (e.g., keyboard, touch screen, mouse), a display interface 224 for interfacing to a display, and a network interface 210 for interfacing to a network, for example, network 104. Network interface 210 can contain several modules to provide the appropriate interface functionality for client 102.

For example, network interface 210 can contain network interface layer 222 which can be a low-level protocol layer to interface with a network (e.g., network 104). TCP/IP layer 220 can be provided above network interface layer 222 for connecting to network 104 via TCP/IP, a standard network protocol. Other protocols 218 can also be provided to allow client 102 to communicate over network 104 using other conventional protocols. In this regard, it is possible for HTTP protocol 212, SNMP protocol 214 and LDAP protocol 216 to be provided in network interface 210 for allowing client 102 to communicate over network 104 via HTTP, SNMP and LDAP protocols, respectively. However, it should be noted that HTTP, SNMP and LDAP protocols, along with other conventional protocols, can instead be provided by operating system 228.

Random access memory (“RAM”) 206 can interface to computer bus 202 to provide central processing unit (“CPU”) 200 with access to memory storage, thereby acting as the main run-time memory for CPU 200. In particular, when executing stored program instruction sequences, CPU 200 can load those instruction sequences from fixed disk 226 (or other memory media) into random access memory (“RAM”) 206 and execute those stored program instruction sequences out of RAM 206. It should also be noted that standard-disk swapping techniques can allow segments of memory to be swapped to and from RAM 206 and fixed disk 226. Read-only memory (“ROM”) 208 can store invariant instruction sequences, such as start-up instruction sequences for CPU 200 or basic input/output operation system (“BIOS”) sequences for the operation of network device devices attached to client 102.

Fixed disk 226 is one example of a computer-readable medium that can store program instruction sequences executable by central processing unit (“CPU”) 200 so as to constitute operating system 228, input interface driver 230 for driving input interface 204, display interface driver 232 for driving display interface 224, network interface driver 234 for driving network interface 210, and other files 236. Operating system 228 can be a windowing operating system, such as Windows 95, Windows 98, Windows 2000, Windows XP, Windows 7, Windows NT, or other such operating system, although other types of operating systems such as DOS, UNIX and LINUX may be used. Other files 236 contain other information and programs necessary for client 102, to operate and to add additional functionality to client 102.

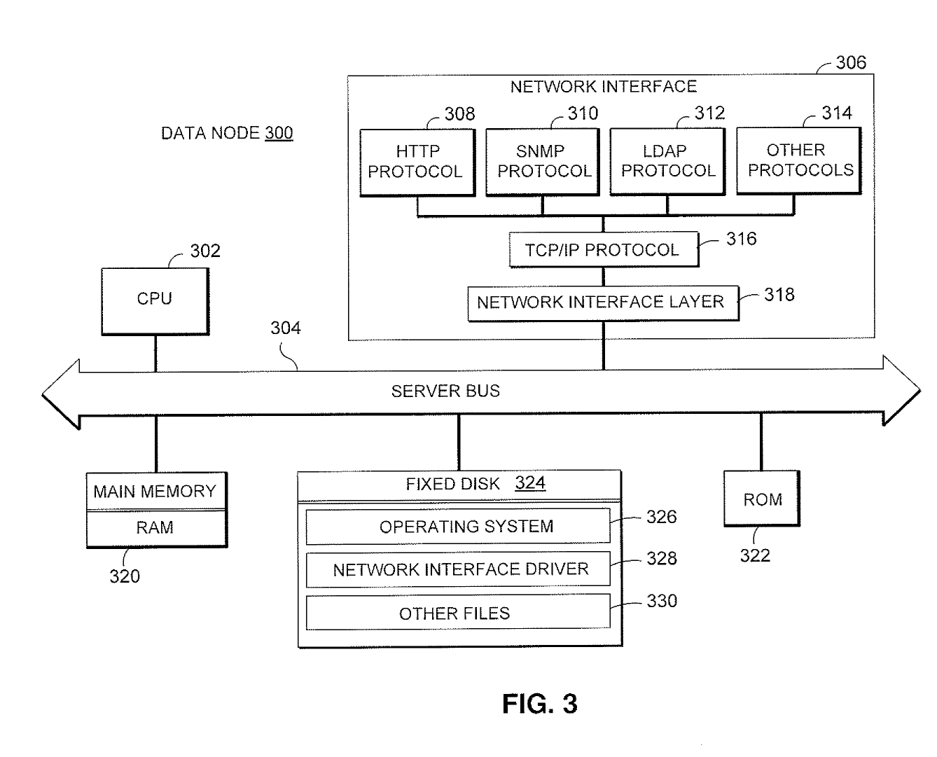

FIG. 3 is a block diagram depicting the internal architecture of a primary host or secondary host shown in FIG. 1 according to an example embodiment. In the example of FIG. 3, data node 300 is used to represent any of primary host 108 or secondary hosts 110. As will be described in greater detail below, data node 300 can store data as files divided into data blocks (e.g., fixed-size blocks). Data node 300 can store the data blocks in local memory, and read or write block data specified by a data block handle and byte range. In addition, each data block can be replicated on multiple data nodes 300.

Data node 300 can include one or more types of server devices, threads, and/or objects that operate upon, search, maintain, and/or manage data. In the example of FIG. 3, an example internal architecture for a server device is described.

Data node 300 can include a central processing unit (“CPU”) 302 such as a programmable microprocessor which can be interfaced to server bus 304. Also coupled to server bus 304 can be a network interface 306 for interfacing to a network (e.g., network 104). In addition, random access memory (“RAM”) 320, fixed disk 324, and read-only memory (“ROM”) 322 can be coupled to server bus 304. RAM 320 can interface to server bus 304 to provide CPU 302 with access to memory storage, thereby acting as a main run-time memory for CPU 302. In particular, when executing stored program instruction sequences, CPU 302 can load those instruction sequences from fixed disk 324 (or other memory media) into RAM 320 and execute those stored program instruction sequences out of RAM 320. It should also be recognized that standard disk-swapping techniques can allow segments of memory to be swapped to and from RAM 320 and fixed disk 324.

ROM 322 can store invariant instruction sequences, such as start-up instruction sequences for CPU 302 or basic input/output operating system (“BIOS”) sequences for the operation of network devices which may be attached to data node 300. Network interface 306 can contain several modules to provide the appropriate interface functionality for data node 300. For example, network interface 306 can contain network interface layer 318, which is typically a low-level protocol layer. TCP/IP protocol 316 can be provided above network interface layer 318 for communicating over a network (e.g., network 104) via TCP/IP. Other protocols 314 can also be provided to allow data node 300 to communicate over network 104 using other conventional protocols. In this regard, it is possible for HTTP protocol 308, SNMP protocol 310, and LDAP protocol 312 to be provided in network interface 306 for allowing data node 300 to communicate to over network 104 using HTTP, SNMP and LDAP, respectively. However, it should be noted that HTTP, SNMP and LDAP protocols, along with other conventional protocols, can instead be provided by operating system 326. The foregoing protocols can allow for data node 300 to communicate over network 104 with other devices (e.g., clients 102).

Fixed disk 324 is one example of a computer-readable medium that stores program instruction sequences executable by CPU 302 so as to constitute operating system 326, network interface driver 328, and other files 330. Operating system 326 can be an operating system such as DOS, Windows 95, Windows 98, Windows 2000, Windows XP, Windows 7, Windows NT, UNIX, or other such operating system. Network interface driver 328 can be utilized to drive network interface 306 for interfacing data node 300 to clients 102 via network 104. Other files 330 can contain other files or programs necessary to operate data node 300 and/or to provide additional functionality to data node 300.

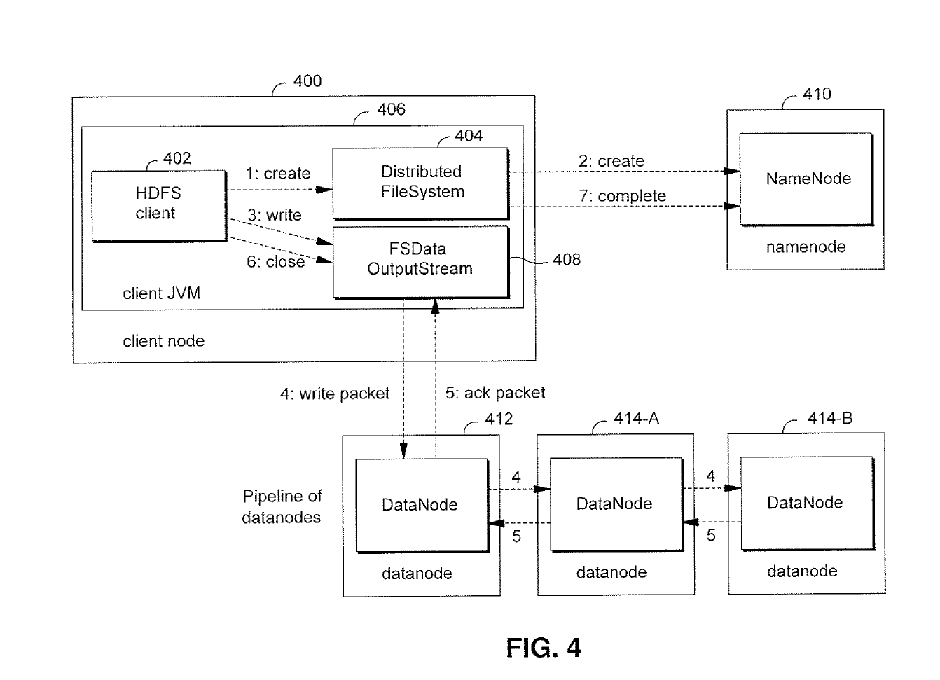

FIG. 4 is a block diagram depicting a system for replication pipelining to multiple nodes in sequence. As noted above, conventional implementations of DFS's make use of replication pipelining, which is typically used for replicating data blocks across multiple participating nodes available in a cluster for high availability and reliability. Data is typically replicated to all the participating nodes in the cluster sequentially one after the other, simulating the flow in a pipeline where the node that just received the data block successfully acts as the data source for the next participating data node in the line. This conventional replication pipelining scheme can provide for ease of implementation in case of error handling, and for simplifying the design of DFS client which needs to handle communication with only one data node at a time.

FIG. 4 illustrates an example of a write operation for implementing an HDFS (Hadoop Distributed File System), which uses a replication pipelining scheme for replication of data blocks. This figure illustrates an example of the main sequence of events when writing to a file and closing when the write operation is complete. As can be seen in FIG. 4, the following steps are illustrated: (1) client create, (2) DFS create, (3) write, (4) write packet, (5) acknowledge packet, (6) close and (7) complete.

More particularly, a client node 400 can include a client java virtual machine (JVM) 406. Client JVM 406 can include an HDFS client 402, a DistributedFileSystem 404 and an FSDataOutputStream 408. To write a file, HDFS client 402 creates a file by calling ‘create’ on DFS 404, which in turns makes a remote call procedure (RPC) call to the NameNode 410 to create a new file in the namespace of the file system, with no blocks associated therewith. DFS 404 returns an FSDataOutputStream 408 for HDFS client 402 to start writing data to. FSDataOutputStream 408 wraps a DFSOutputStream (not shown) which handles communication with DataNodes 412 to 414 and NameNode 410.

As HDFS client 402 writes data, DFSOutputStream splits it into packets, and writes them to an internal queue called the data queue (not shown). The data queue is consumed by a data streamer (not shown), which has the responsibility to ask NameNode 410 to allocate new blocks by picking a list of suitable DataNodes (e.g., DataNodes 412 to 414) to store the replicas. The list of DataNodes 412 to 414 forms a pipeline.

The data streamer streams the packets to the first data node (e.g., DataNode 412) in the pipeline, which stores the packet and forwards it to the second data node (e.g., DataNode 414-A) in the pipeline. In a similar manner, the second data node stores the packet and forwards it to the third and last DataNode (e.g., DataNode 414-B) in the pipeline. DFSOutputStream also maintains an internal data queue of packets that are waiting to be acknowledged by DataNodes 412 to 414, called the acknowledge queue (not shown). A packet is removed from the acknowledge queue only when it has been acknowledged by all DataNodes 412 to 414 in the pipeline.

If any of DataNodes 412 to 414 fail while data is being written to it, then the following actions can be taken: (a) the pipeline is closed, and any packets in the acknowledge queue are added to the front of the data queue, so that DataNodes 412 to 414 which are downstream from the failed node will not miss any packets; (b) the current block on the successful data nodes is given a new identity, which is communicated to NameNode 410, so that the partial block on the successful data nodes will be deleted if the failed data node recovers later on; (c) the failed data node is removed from the pipeline, and the remainder of the block's data is written to the two successful data nodes in the pipeline; and (d) NameNode 410 notices that the block is under-replicated, and arranges for a further replica to be created on another node. Subsequent blocks are then treated as normal.

When HDFS client 402 has finished writing the data it calls ‘close’ on the stream. This action flushes all the remaining packets to the DataNode pipeline and waits for acknowledgements before contacting NameNode 410 to signal that the file is complete.

In this regard, NameNode 410 already knows which blocks make up the file (e.g., via the data streamer asking for block allocations), so NameNode 410 typically only has to wait for blocks to be minimally replicated before successfully returning.

Thus, the above-described replication pipelining system can be seen to be robust in implementation and to improve data consistency. However, there is a tradeoff in terms of the time at which the data is made available for reading for a given data block, particularly when there is a high replication factor, extremely large files (e.g., several Gigabytes), and large minimum block sizes in the DFS instance. Thus, the foregoing replication pipelining scheme is not without problems.

As mentioned above, one issue with the foregoing scheme is that a data block is made available for reading only once it is successfully copied to all the participating replication nodes, thus significantly increasing the time to wait before the first use of a data block in DFS systems with a high replication factor. In addition, a data block is copied to one participating replication node in the cluster at a time, while the other participating nodes in the cluster might be sitting idle with abundantly available network bandwidth, hence introducing propagating sequential delay in availability of a given data block. Further, extremely large files will typically have a high number of constituent data blocks and thus can adversely affect the data availability time, in light of the overhead involved in handling the block level replication. Moreover, while the usage of large minimum block sizes can mitigate the adverse effect of having extremely large file sizes to a certain extent (e.g., by reducing the block handling overheads), using large block sizes typically results in having to wait at each replication node longer for completing the data write at that node before moving on to the next.

With the releases of HDFS, the replication scheme has been improvised along with other improvements ensuring that a node participating in replication at a given point of time can both receive and transfer data blocks at any given instant, thus resulting in the elimination of additional wait time. For example, after the improvements, the time consumption order can be as shown below in Table 1:

TABLE 1
HDFS Replication Pipeline Time Requirements

| Time | A | B | C | D |
|---|---|---|---|---|
| 1 | B1 | — | — | — |
| 2 | B2 | B1 | — | — |
| 3 | B3 | B2 | B1 | — |
| 4 | B4 | B3 | B2 | B1 |
| 5 | B5 | B4 | B3 | B2 |
| 6 | B6 | B5 | B4 | B3 |
| 7 | B7 | B6 | B5 | B4 |
| 8 | B8 | B7 | B6 | B5 |
| 9 | B9 | B8 | B7 | B6 |
| 10 | — | B9 | B8 | B7 |
| 11 | — | — | B9 | B8 |
| 12 | — | — | — | B9 |

As such, with releases of HDFS for a file with replication factor of 4, only 3 additional time units are consumed. Thus, assuming if it takes 1 time unit (t) to copy a 64 MB data block on a given data node in such an HDFS cluster, putting a 1G file comprising of 16 such blocks can take a maximum of 19 time units only (19t). This suggests that the time consumption is linear. The same would likely take 64 time units with legacy releases of HDFS, although actual measurements have indicated that the time consumption is exponential, as opposed to being linear as suggested by the scheme.

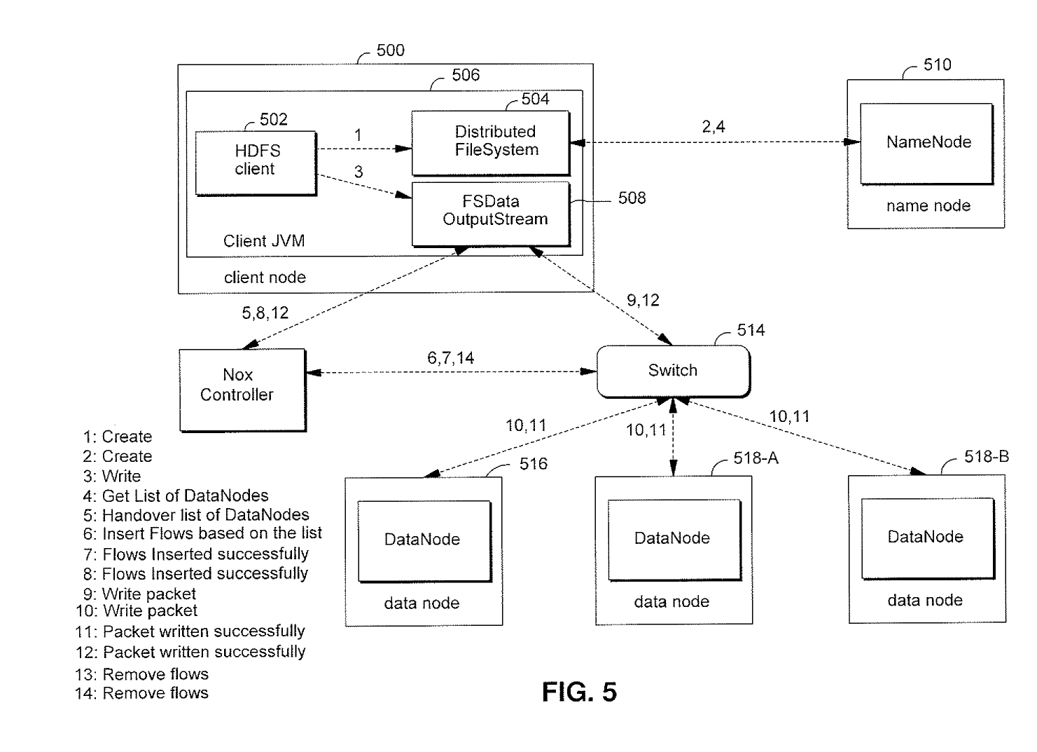

FIG. 5 is a block diagram depicting a system for replicating data to multiple nodes in parallel, according to an example embodiment. In this regard, a network switch with real-time flow modification capabilities can be used to improve performance when replicating data to multiple nodes in parallel. For example, OpenFlow-enabled switches coupled with OpenFlow controllers (e.g., Nox controllers) can provide for the capability to programmatically insert or remove the flows from the switch. Using such a switch in the example embodiments described herein can address the problem of more efficiently replicating data across data nodes in a DFS cluster, by enabling data writes in parallel. In addition, although FIG. 5 illustrates an HDFS (Hadoop Distributed File System), it should be noted that other distributed file systems can be used.

As can be seen in FIG. 5, the following steps are illustrated: (1) client create, (2) DFS create, (3) write, (4) get list of data nodes, (5) hand over list of data nodes, (6) insert flows based on the list, (7) flows inserted successfully, (8) flows inserted successfully, (9) write packet, (10) write packet, (11) packet written successfully, (12) packet written successfully, (13) remove flows and (14) remove flows.

More particularly, a client node 500 can include a client JVM 506. Client JVM 506 can include an HDFS client 502, a DistributedFileSystem 504, and an FSDataOutputStream 508. To write a file, HDFS client 502 can create a file by calling ‘create’ on DistributedFileSystem 506, which in turns can make an RPC call to a NameNode 510 to create a new file in the namespace of the file system, with no blocks associated therewith. DistributedFileSystem 504 can return an FSDataOutputStream 508 for HDFS client 502 to start writing data to. FSDataOutputStream can wrap a DFSOutputStream (not shown) which handles communication with DataNodes 516 to 518 and NameNode 510. In this regard, DataNode 516 can correspond to primary host 108, and DataNodes 518-A and 518-B (collectively referred to as DataNodes 518) can correspond to secondary hosts 110.

As HDFS client 502 writes data, DFSOutputStream can split the data into packets, and write them to an internal queue called the data queue (not shown). Data queue can be consumed by a data streamer (not shown), which has the responsibility is to ask NameNode 510 to allocate new blocks by picking a list of suitable DataNodes (e.g., DataNodes 516 to 518) to store the replicas. The list of DataNodes can be seen to form a pipeline. However, in the example system of FIG. 5, data is replicated in parallel rather than in sequence.

The data streamer can contact a controller (e.g., Nox controller 512), and provide the details regarding the current block, including the block number and the list of data nodes participating in the replication for this data block. Nox controller 512 can synthesize this information and generate a series of control commands (e.g., OpenFlow control commands) to be sent to a switch 514, which connects client node 500 to DataNodes 516 to 518 in the cluster. These OpenFlow control commands can insert the flow entries into switch 514. As such, switch 514 can be instructed to replicate the packets, which come in for the connection between HDFS client node 502 and the first data node (e.g., DataNode 516), across all of the data nodes (e.g., DataNodes 518) participating in the replication. This can result in the data being sent out to all the participating DataNodes (e.g., DataNodes 516 and 518) in parallel.

It should be noted that while OpenFlow can be employed for communication between Nox controller 512 and switch 514, other configurations with real-time flow modification can be employed. For example, the switch can be implemented as a proprietary switch (e.g., a proprietary Cisco switch with real-time flow modification capabilities), and the controller can be capable of communicating with this switch to modify data flow in real-time.

Next, the data streamer can stream the packets to first DataNode 516. Switch 514 can tap the TCP packets flowing across it, identify the flow entries, and start replicating each outgoing data packet from client node 500 to all the participating data nodes (e.g., DataNodes 518) based on the flow entries. DataNodes 516 to 518 can start receiving the data in parallel and send an acknowledgment at completion. A data node software component of HDFS (not shown) can be modified to ensure that a given data node will not forward the data to the next participating node.

DFSOutputStream can also maintain an internal data queue of packets waiting to be acknowledged by DataNodes, called the acknowledgement queue (not shown). A packet can be removed from the acknowledgement queue only when it has been acknowledged by all DataNodes 516 to 518 in the pipeline. When HDFS client 502 has finished writing the data, it can call ‘close’ on the stream. This action can flush all the remaining packets to the data node pipeline and wait for acknowledgements before contacting NameNode 510 to signal that the file is complete. NameNode 510 can already know which blocks the file is made up of (e.g., via data streamer asking for block allocations), so NameNode 510 only has to wait for blocks to be minimally replicated before successfully returning.

If any of DataNodes 516 to 518 fail while data is being written to it, then the following events, which can be transparent to the client writing the data, can occur: (a) since HDFS client 502 can assume it is writing the data only to the first data node (e.g., DataNode 516) in the list, if it identifies a failure, HDFS client 502 can stop the data transfer and signal it failed. However, if any other data node (e.g., any of DataNodes 518) fails, the transfer can continue uninterrupted for the rest of the data nodes, until the entire data is written; (b) after completion, a timeout mechanism can be employed at HDFS client 502 to ensure that it receives acknowledgement from all DataNodes 516 to 518; (c) all of the data nodes which are successful can send a positive acknowledgement upon completion of the data transfer, while the failed data node does not; (d) the current block on the successful nodes can be given a new identity, which is communicated to NameNode 510, so that the partial block on the failed data node can be deleted if the failed data node recovers later on; (e) NameNode 510 can recognize that the block is under-replicated, and arrange for a further replica to be created on another node. Subsequent blocks can then be treated as normal.

Thus, in view of the foregoing, it is possible to address the problems associated with conventional replication pipelining schemes. As noted above, these problems include the increased time at which data is made available for reading for a given data block. Further, the problem is exacerbated when there is a high replication factor, large data files, and/or large minimum block sizes in the DFS instance. In addressing these problems, all modules in a DFS other than the client are seen to be unaware of (or not impacted by) the foregoing performance improvement scheme.

In this regard, HDFS client 502 can be modified to accept connection details from Nox controller 512, and to utilize the connection details to connect to Nox controller 512. HDFS client 502 can communicate with Nox controller 512 to issue flow entry or removal commands.

In addition, a new component can be introduced to run on top of Nox controller 512, and to mediate between switch 514 (e.g., an OpenFlow switch) and HDFS client 502. This new component can accept incoming connection requests from HDFS client 502, accept flow entry, deletion or modification commands from HDFS client 502, and issue control commands (e.g., OpenFlow protocol control commands) to switch 514.

The system can be modified to support two modes of operation, namely a default mode which provides default HDFS behavior, and an enhanced mode, which provides that modified HDFS behavior when utilizing the real-time modification flow scheme. As such, DataNodes 516 to 518 can be modified to accept incoming data from HDFS client 502 independently, when running in the enhanced mode. In addition, DataNodes 516 to 518 can be modified to ensure that the received data is not forwarded or replicated to the next node participating in the pipeline when running in the enhanced mode.

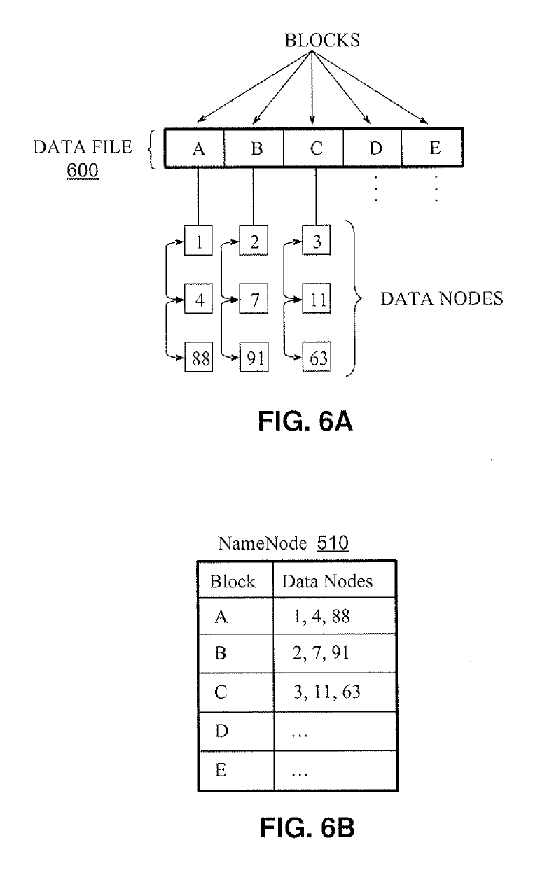

FIGS. 6A and 6B are block diagrams depicting data replication on a per-block basis according to an example embodiment. A data file can be divided into data blocks, and the nodes participating in the replication for each data block can differ from the nodes participating for other data blocks. FIGS. 6A and 6B illustrate an example of how data blocks can be divided when data is replicated in the above-described system of FIG. 5. Of course, the system of FIG. 5 is not limited to data replication using blocks divided in this manner.

As mentioned above, a data node (e.g., DataNodes 516 to 518) can store data as files divided into data blocks (e.g., fixed-size blocks). FIG. 6A illustrates an example of a data file 600 divided into blocks, which are individually labeled as blocks A through E. A list of corresponding data nodes is associated with each block. In this example, block A is associated with data nodes 1, 4 and 88, block B with data nodes 2, 7 and 91, and block C with data nodes 3, 11 and 63. For example, block A can be replicated to data nodes 1, 4 and 88, with data node 1 corresponding to a primary host (e.g., data node 516 of FIG. 5) and with data nodes 4 and 88 corresponding to secondary hosts (e.g., data nodes 518 of FIG. 5).

As discussed above, the list of data nodes for replication can be provided by NameNode 510. In the example of FIG. 6B, NameNode 510 references blocks A through E. In addition, for each of blocks A through E, NameNode 510 provides a list of data nodes for replication. As such, it is possible to associate each block with a list of corresponding data nodes for replication.

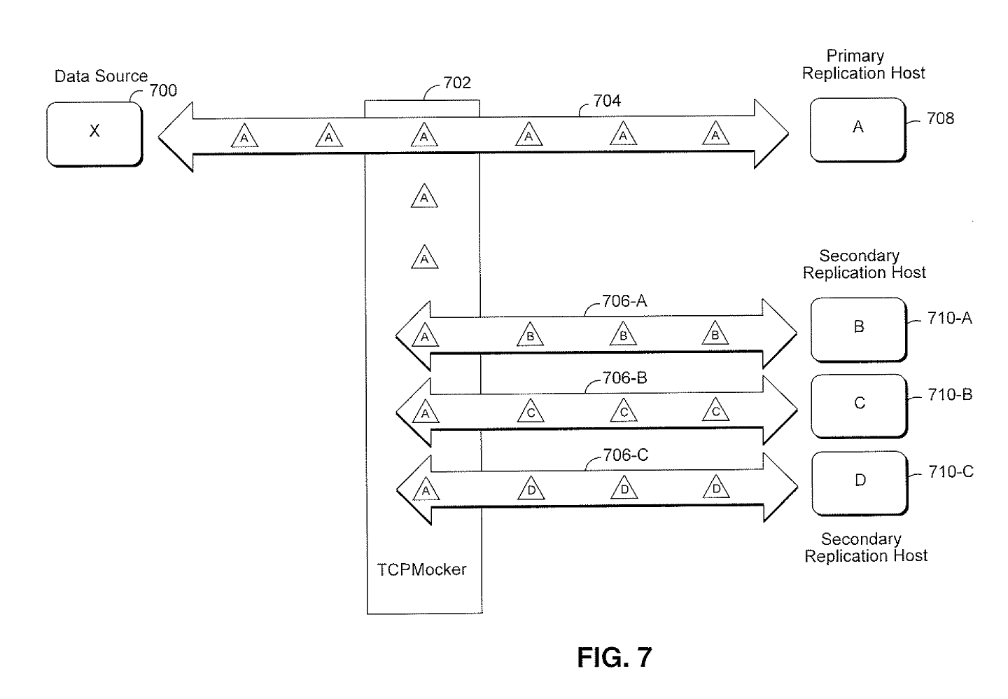

FIG. 7 is a block diagram depicting a system which uses a TCPMocker for replicating data to multiple nodes in parallel, according to an example embodiment. In this regard, HDFS can use an application layer custom protocol that runs on top of TCP to perform and manage distributed file system activities and operations. Thus, to achieve improved multipath data transfer, TCP flow entries can be dynamically inserted and removed into real-time flow modification switches (e.g., OpenFlow switches or proprietary switches), to replicate data packets of one connection and send them to multiple destinations at once.

However, TCP is a connection-oriented protocol and typically requires an established connection before any data transfer takes place. In conventional systems, the additional data nodes are generally ready and waiting for data over open TCP sockets. However, the HDFS client node which is sending the data is typically unaware of the additional data nodes receiving the data packets. The conventional design is seen to be incapable of handling these pseudo TCP connection messages and requests, resulting in the system being nonoperational.

The use of a TCPMocker as described herein addresses the foregoing problems. In one example, TCPMocker can be implemented as a custom Linux based software component developed in C++, and designed to mock a TCP connection. Of course, other implementations for TCPMocker can be employed.

As can be seen in FIG. 7, TCPMocker 702 can tap a stream of incoming TCP packets 704 from the set of hosts it is configured to monitor. In this regard, TCPMocker can categorize the hosts that it manages into three categories: (1) data source 700, (2) primary replication host 708, and (3) secondary replication hosts 710-A, 710-B and 710-C (collectively referred to as replication hosts 710).

Each configured data source 700 can be associated with a primary replication host 708 and one or more secondary replication hosts 710 for monitoring. TCPMocker 702 can tap the TCP packets flowing in connection stream 704 between data source 700 and primary replication host 708. Based on this data stream, TCPMocker 702 can set up mocked TCP connection streams (e.g., connection streams 706-A, 706-B and 706-C, collectively referred to as connection streams 706) between itself and secondary replication hosts 710, forging itself as the data source. All of secondary replication hosts 710 may believe that they are connected to data source 700 and are receiving data therefrom. However, secondary replication hosts 710 can actually be connected to TCPMocker 702, which modifies the destination addresses in the incoming packets with additional housekeeping for TCP handling and distributes the packets via connection streams 706 to all connected secondary replication hosts 710.

Regarding system performance for the above-described examples of data replication in parallel, it may be possible to achieve constant time data replication performance across the cluster, irrespective of the number of data nodes, with a small variable amount of time added due to overhead. For an example of overhead, TCPMocker processing time can vary based on the number of secondary replication nodes.

In this regard, if ‘t’ is a unit of time that it takes to copy a 64 MB data block on a given data node in a HDFS cluster for a 1G file with replication order of 4, then it may be possible to have time consumptions with different approaches as shown in Table 2, where x=variable amount of overhead time consumed by a component such as TCPMocker:

TABLE 2
Benchmarking Possible HDFS Performance
with Different Replication Schemes

| Replication | File | Block | Number | Replication | |
|---|---|---|---|---|---|
| Scheme | Size | Size | of Blocks | order | Time |
| HDFS | 1 G | 64 MB | 16 | 4 | 64 t |
| primitive | | | | | |
| HDFS | 1 G | 64 MB | 16 | 4 | 19 t |
| Latest | | | | | |
| OpenFlow | 1 G | 64 MB | 16 | 4 | 16 t + x |
| based | | | | | |

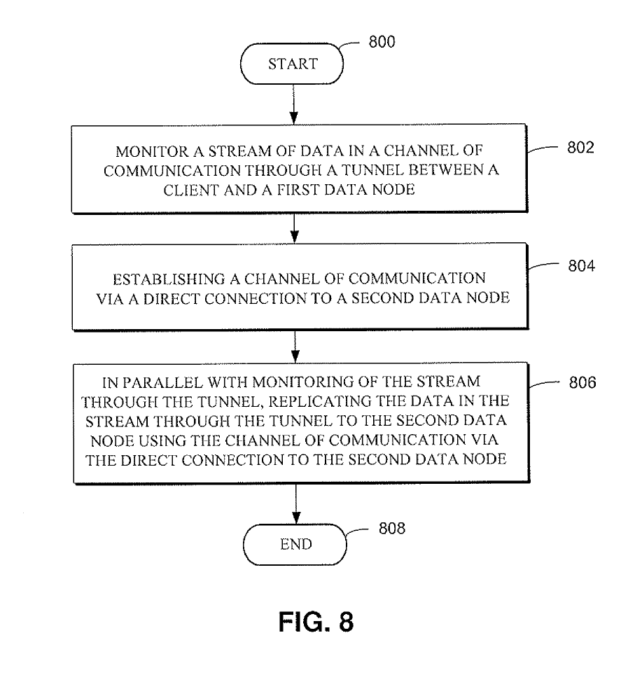

FIG. 8 is a flow diagram illustrating data replication to multiple data nodes according to an example embodiment. Following start bubble 800, a stream of data is monitored in a channel of communication through a tunnel between a client and a first data node (block 802).

A channel of communication is established via a direct connection to a second data node (block 804). The establishing of the channel of communication to the second data node can comprise impersonating the client relative to the second data node. The second data node can be identified within a list of data nodes for data replication.

In parallel with monitoring of the stream through the tunnel, the data in the stream through the tunnel is replicated to the second data node using the channel of communication via the direct connection to the second data node (block 806). The process then ends (end bubble 808).

The data can comprise plural data blocks, and parallel operation can comprise sending one of the data blocks to the first and second data nodes simultaneously. The data can be replicated on a per-block basis, wherein a data file is divided into data blocks, and the nodes participating in the replication for each data block differ from nodes participating for other data blocks.

In addition, an acknowledgment can be received from each of the first and second data nodes upon completion of data transfer. Furthermore, a channel of communication can be established via a direct connection to a third data node, and the data stream through the tunnel can be replicated to the third data node using the channel of communication via the direct connection to the third data node.

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method for replicating data to multiple data nodes including first and second data nodes, the method comprising:
monitoring a stream of data in a channel of communication through a tunnel between a client and the first data node;
establishing a channel of communication via a direct connection to the second data node; and
in parallel with monitoring of the stream through the tunnel, replicating the data in the stream through the tunnel to the second data node using the channel of communication via the direct connection to the second data node.

2. The method according to claim 1, wherein establishing the channel of communication to the second data node further comprises the step of impersonating the client relative to the second data node.

3. The method according to claim 1, wherein the data comprises plural data blocks, and parallel operation comprises sending one of the data blocks to the first and second data nodes simultaneously.

4. The method according to claim 1, further comprising:
establishing a channel of communication via a direct connection to a third data node; and
replicating the data stream through the tunnel to the third data node using the channel of communication via the direct connection to the third data node.

5. The method according to claim 1, wherein the second data node is identified within a list of data nodes for data replication.

6. The method according to claim 1, further comprising receiving an acknowledgment from each of the first and second data nodes upon completion of data transfer.

7. The method according to claim 1, wherein the data is replicated on a per-block basis, wherein a data file is divided into data blocks, and the nodes participating in the replication for each data block differ from nodes participating for other data blocks.

8. A distributed file system (DFS) comprising:
a client node having data for replication;
first and second data nodes;
a switch which includes a data tunnel between the client node and the first data node; and
a controller which receives instructions from the client node to replicate the data to the second data node, and which controls the switch to replicate the data to the second data node,
wherein the switch is further constructed to open a data channel with the second data node, to monitor data through the tunnel to the first data node, to impersonate the client relative to the second data node, and to replicate data to the second node via the data channel in parallel with monitoring of data through the tunnel to the first data node.

9. The system according to claim 8, wherein the switch is further constructed to open multiple channels to multiple data nodes, to impersonate the client relative to each of the multiple data nodes, and to replicate the data monitored through the channel to the first data node to all of the multiple data nodes.

10. The system according to claim 8, wherein the switch is a network switch with real-time flow modification capabilities.

11. The system according to claim 8, wherein the data is replicated on a per-block basis, wherein a data file is divided into data blocks, and the nodes participating in the replication for each data block differ from nodes participating for other data blocks.

12. An apparatus comprising:
a computer-readable memory constructed to store computer-executable process steps; and
a processor constructed to execute the computer-executable process steps stored in the memory;
wherein the process steps stored in the memory cause the processor to replicate data to multiple data nodes including first and second data nodes, the process steps comprising:
monitoring a stream of data in a channel of communication through a tunnel between a client and the first data node;
establishing a channel of communication via a direct connection to the second data node; and
in parallel with monitoring of the stream through the tunnel, replicating the data in the stream through the tunnel to the second data node using the channel of communication via the direct connection to the second data node.

13. The apparatus according to claim 12, wherein establishing the channel of communication to the second data node further comprises the step of impersonating the client relative to the second data node.

14. The apparatus according to claim 12, wherein the data comprises plural data blocks, and parallel operation comprises sending one of the data blocks to the first and second data nodes simultaneously.

15. The apparatus according to claim 12, the process steps further comprising:
establishing a channel of communication via a direct connection to a third data node; and
replicating the data stream through the tunnel to the third data node using the channel of communication via the direct connection to the third data node.

16. The apparatus according to claim 12, wherein the second data node is identified within a list of data nodes for data replication.

17. The apparatus according to claim 12, the process steps further comprising receiving an acknowledgment from each of the first and second data nodes upon completion of data transfer.

18. A computer-readable memory medium on which is stored computer-executable process steps for causing a computer to perform replicating data to multiple data nodes including first and second data nodes, the process steps comprising:
monitoring a stream of data in a channel of communication through a tunnel between a client and the first data node;
establishing a channel of communication via a direct connection to the second data node; and
in parallel with monitoring of the stream through the tunnel, replicating the data in the stream through the tunnel to the second data node using the channel of communication via the direct connection to the second data node.

19. The computer-readable memory medium according to claim 18, wherein establishing the channel of communication to the second data node further comprises the step of impersonating the client relative to the second data node.

20. The computer-readable memory medium according to claim 18, wherein the data comprises plural data blocks, and parallel operation comprises sending one of the data blocks to the first and second data nodes simultaneously.
